(19) United States
(12) Patent Application Publication
(10) Pub. No.: US 2005/0093879 A1
(43) Pub. Date: May 5, 2005

(54) Device characterization color target creation system

(76) Inventors: Joan M. Zanghi, Rochester, NY (US); Kevin M. Gobeyn, Honeoye Falls, NY (US); Geoffrey J. Woolfe, Penfield, NY (US); King F. Choi, Lexington, MA (US); George B. Pawle, North Reading, MA (US); Michael S. Schwartz, Belmont, MA (US)

Correspondence Address: Thomas H. Close;Patent Legal Staff, Eastman Kodak Company, 343 State Street, Rochester, NY, 14650-2201, US

(21) Appl. No.: 10/700,127

(22) Filed: Oct. 31, 2003

(51) Int. Cl. G09G 5/02

(52) U.S. Cl. 345/589

(57) ABSTRACT

The present invention is directed to a system that produces a characterization target for an existing input/output device using fixed control values and dynamically created control values. The fixed control values are chosen from the existing device color space and provide a sample of the gamut of the device. Important colors are dynamically chosen from a number of different sources including user selections, device target measurements and visual neutrals, and dynamically converted into corresponding colorimetric values. An existing characterization associated with the existing device is used to dynamically convert the colorimetric values into the dynamic control values. The fixed and dynamic control values are used to generate the target. The color patches of the target can be arranged to reduce errors in target reproduction and to allow visual confirmation of the target. The target can then be output, measured and used to characterize the device.

### FIELD OF THE INVENTION

The present invention is directed to a system for creating a target useful for characterizing a color device and, more particularly, to a system that dynamically creates a target including fixed color values and dynamic color values created using an existing device characterization.

### BACKGROUND OF THE INVENTION

The characterization of a device, such as a color printer, can be divided into three stages: 1) the creation of a characterization target that includes many color regions or patches; 2) the measurement of these color patches by the use of calorimeters of spectrophotometers; and 3) the generation of a characterization for the output device based on the color patches and measurements. The characterization is often saved in a file, such as a conventional International Color Consortium (ICC) output profile.

Typically, the patches on a color characterization target represent fixed device control values, typically a uniform sample covering the device color space. A MacBeth Color Checker is a type of static target that has fixed values. The fact that the patches are defined in terms of color values can cause problems if the device properties are such that visually important colors or visually important regions of color space are not represented by a sufficient number of patches. For this reason people have developed methods for generating dynamic targets.

Pertaining to the first stage of output device characterization, Balasubramanian et al., in U.S. Pat. No. 6,381,037 describes a dynamic method for creating color patches that reflect a portion of an output device color gamut. This is done by the selection of an output device model that best matches the actual physical measurements. The same authors, in U.S. Pat. No. 6,441,923, describe another dynamic method for creating color patches based on variable print settings. These variable print settings are output device settings that can be explicitly or implicitly influenced by the operator, and directly or indirectly affect color reproduction of the output device. However, these output settings might not be known or available in all cases. Furthermore, it is not conventionally clear how to generalize their method to other types of device.

What is needed is a system for dynamically generating a target where no output device model or settings are used or needed. What is needed is a system in which the characterization target is dynamically created based on an existing characterization of the output device, such as an ICC output profile. The existing characterization might be an older characterization previously made for the device. For an output device that does not have any previous characterization, a profile from a similar device may be used. If no such profile is available, a conventional static target, such as often included with a high-end output device, can be used to create an initial profile. This initial profile of the output device will then be used to create a new characterization target.

### SUMMARY OF THE INVENTION

It is an aspect of the present invention to provide a dynamically created characterization target.

It is another aspect of the present invention to provide a target with a useful topology.

It is a further aspect of the present invention to provide a process that creates a dynamic target from a number of different input sources.

It is a further aspect of the present invention to provide a dynamically created target that better characterizes important colors.

The above aspects can be attained by a system that produces a characterization target for an existing device using fixed control values and dynamically created values. The fixed control values are chosen from the existing device color space. Important colors are chosen from a number of different sources and dynamically converted into corresponding colorimetric values. A characterization for the existing device is used to dynamically convert the colorimetric values into dynamic control values. The fixed and dynamic control values are used to generate the target. The color patches of the target can be arranged to reduce errors in target reproduction and to allow visual confirmation of the target.

These together with other aspects and advantages that will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a flowchart illustrating the operations of the present invention.

FIG. 2 depicts more detailed operations of the present invention.

FIG. 3 shows the hardware of the present invention.

FIG. 4 shows a target according to the present invention.

FIGS. 5 and 6 depict errors in the target.

FIG. 7 depicts a target divided into sub-targets.

### DETAILED DESCRIPTION OF THE INVENTION

The present invention is directed to a dynamically created characterization target that is used for characterizing an output device, such as a printer or CRT, and a method and apparatus for dynamically creating the target. This target includes two main groups of color patches. The first group preferably includes a fixed or static set of color patches. Typically these color patches uniformly sample the output device's color space according to the output device's control values. An 8-bit (control values range from 0 to 255), three-channel RGB (red, green, and blue) output device, such as a CRT display, can be sampled using a 6-cubed uniform sample. A sample set for this device can typically include output values at the control values of 0, 51, 102, 153, 204, 255 for each of the three channels resulting in a selection of 6×6×6=216 color patches. A uniform sample at different control values than those noted above is also possible. Similarly, additional patches along balanced neutral (R=G=B) or near neutral (R, G, and B are close in value but not all equal) can also be included in this fixed set.

The second group of target color patches preferably includes dynamically generated color patches based on important colors, i.e., on colors whose accurate reproduction is particularly important to the user of the output device. Typical choices for important colors are the important colors in pictorial images, such as skin color, sky blue, foliage green, visual neutral, etc. These color patches are specified in terms of calorimetric values (such as CIE tristimulus values XYZ or the derived CIELAB values). The calorimetric values for these important colors can come from well-known databases or from direct calorimetric measurements of objects of interest. The corresponding output device control values for these colors are calculated using the existing characterization of the output device. The group of dynamically generated color patches is combined with the fixed group of color patches to form a new characterization target.

The arrangement, layout or topology of the color patches on the target can be random or can have an organization that allows easy visual verification of the target or is adapted to the characteristic behavior of he device being characterized with the target. For example, target patches that are close to each other in color can be arranged to correspond to a direction of printing so that devices with step function sensitivities, such as heated head ink jet printers, do not produce inaccurate patches. The target is output on the output device using the typical media for the device and the patches are measured to determine the actual colorimetric values of the patches. These measurements are used to generate a new characterization or profile of the output device.

The advantage of generating patches as described above is that the resulting characterization target will contain patches whose colors are near all of the important colors. Because the target contains patches near the important colors, the resulting profile will be more accurate near the important colors than a profile generated using a conventional target.

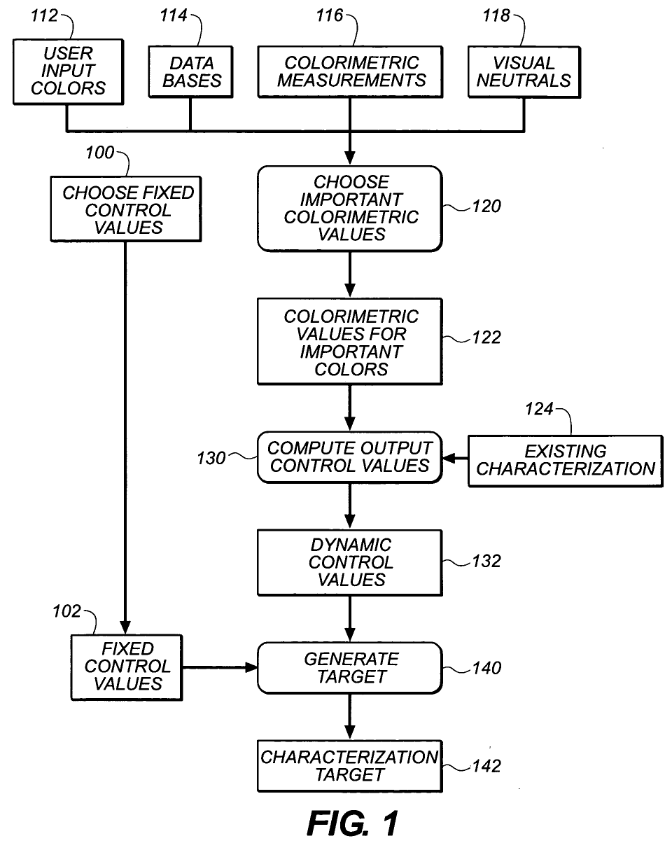

Referring to FIG. 1, there are several sources of possible input color values, typically including user input color values 112 such as a favorite color or a trademark color, databases 114, colorimetric measurements 116, visual neutrals 118. There is an existing characterization 124 and there are several sub-parts 100, 120, 130, and 140 of a computer program that are used for implementing the present invention. Although the computer sub-programs 100, 120, 130, and 140 are shown for the purpose of illustrating a preferred embodiment, the present invention is not limited to these particular computer sub-programs 100, 120, 130 and 140 shown, but may use programs on any electronic processing system such as found in home computers, kiosks, retail, or any other system for the processing of digital images.

Computer sub-program 100 conventionally generates a set of fixed control values 102. Such set of control values could be considered the standard set for characterizing the device. Several methods for generating sets of fixed control values are known to those skilled in the art. In this embodiment, the fixed control values preferably include equal RGB neutral control values, near neutral control values, control values corresponding to color ramps, and a grid (8×8×8) of control values that encompass the entire range of possible control values. Such or similar control values can be called a predetermined set and it is possible that they can be obtained from a data set that comes with the device.

Computer sub-program 120 dynamically generates or chooses/selects a set of calorimetric values corresponding to colors considered to be important. This set can include particular colors 112 selected by the user; the visual neutrals 118; other colors of visually important objects, such as skin, sky, and foliage; and colors which are important for a particular application, such as logos. These colors can be obtained from various color databases 114 such as the Pantone set or the Munsell set, or could be measured directly 116. The result of this operation is a set of calorimetric values 122.

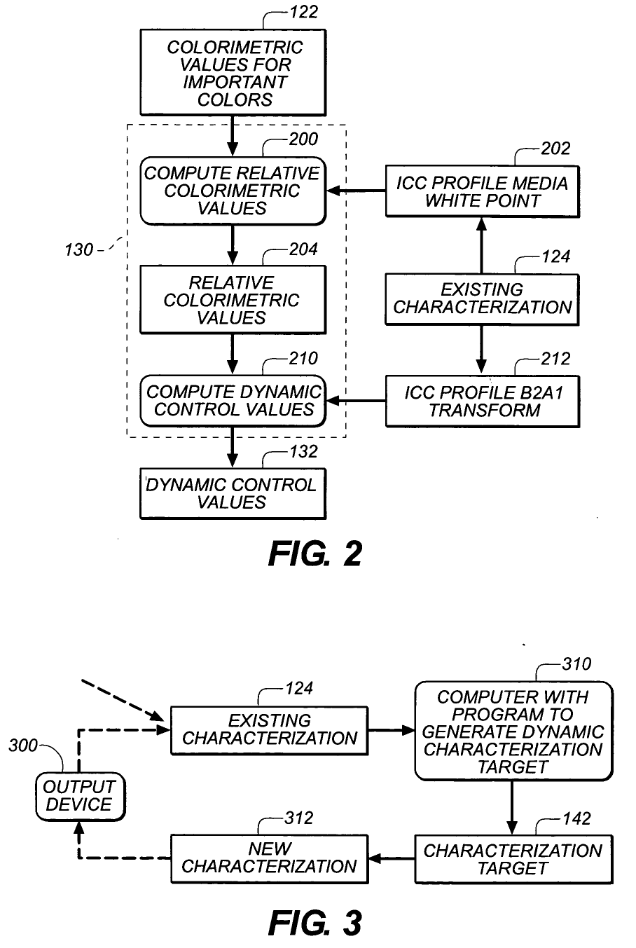

Computer sub-program 130 conventionally converts the colorimetric values 122 into dynamically created output control values 132 using the existing characterization 124. The exact set of conventional equations for producing output control values from calorimetric values depends on the exact embodiment of the existing characterization. The existing characterization is preferably the characterization for the particular device for which a characterization target is being created, such as a characterization created at the factory when a scanner is final tested or one that can be created when a scanner is installed. However, the characterization can be an existing characterization for a group of devices of which the device is a member, such as a characterization for a model of printers. The characterization can also be a characterization for a similar device, such as a CRT similar to the CRT for which a target is being created. The characterization can also be one that is generated using a conventional static target. Sub-program 130 will be described in more detail with respect to FIG. 2.

The resulting control values 132 will not produce patches for the target whose measured colors are exactly the same as the color values 122 because the existing output characterization is only approximately correct. However, as long as the existing characterization is approximately correct, the colors of the dynamic patches of the target will be close to the important colors. Because the characterization target contains patches whose colors are close to important colors, the profile resulting from using this target will have enhanced accuracy for colors that are at or close to the important colors. Computer subprogram 140 combines the fixed control values 102 with the dynamic control values 132 to form the new dynamic characterization target 142. A list mapping color values within color files for the control values 102 and 132 to target locations in a tif file can be used to place the control values in the proper or desired locations to produce the corresponding target in a manner like conventional static targets are created.

As depicted in FIG. 2, the sub-program 200 within 130 converts the calorimetric values 122 from absolute calorimetric values to relative calorimetric values 204 by normalizing them with the ICC profile, media white point value 202. The white point value 202 is the colorimetric value representing the color of the output device's medium, which is part of the characterization 124. The ICC profile contains this required media white point value in an ICC tag labeled “wtpt”, as described in International Color Consortium® Specification ICC.1:2001-12, File Format for Color Profiles (Version 4.0.0) (see http://www.color.org/icc_specs2.html) incorporated by reference herein.

The sub-program 210 within 130 then converts the relative colorimetric values 204 to output control values 132 by using the ICC profile “B2A1” transform 212, which is also part of the characterization 124. The “B2A1” tag in an ICC profile contains information specifying a transformation from relative colorimetric values to output code values. This colorimetric output transformation can be retrieved from the output characterization ICC profile using ICC tag “B2A1”. The above ICC Specification describes this tag in detail and also describes how to use the information in this tag to perform the required transformation.

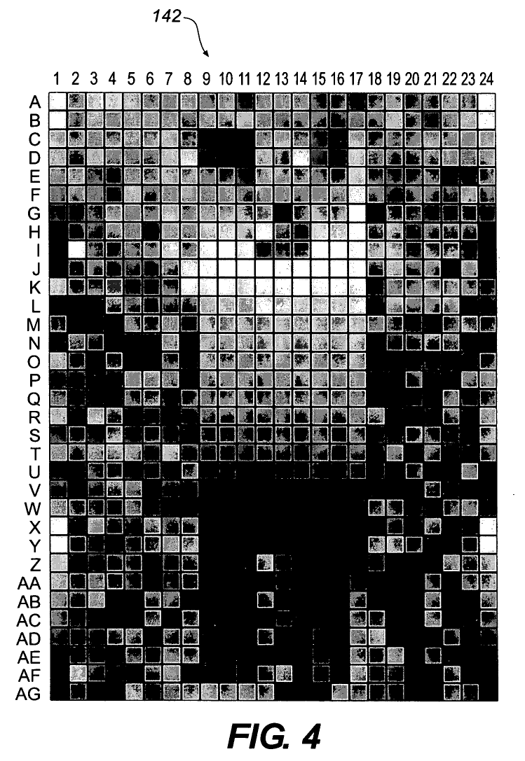

FIG. 3 depicts the hardware of the present invention and the relationship between an output device 300, such as a printer, and other components. The existing characterization 124 shown associated with the output device 300 can come from the existing device 300 or from another source, such as a similar device or a generic profile from a database, along with the other inputs depicted in FIG. 1, serves as inputs to a conventional computer 310, which can be any well-known computer system, such as a personal computer. Consequently, the computer system 310 will not be discussed in detail herein. Based on these inputs, the computer 310 generates the new characterization target 142. Conventional colorimetric measurements are made of this characterization target 142 and a new characterization 312 can be conventionally generated for the device 300.

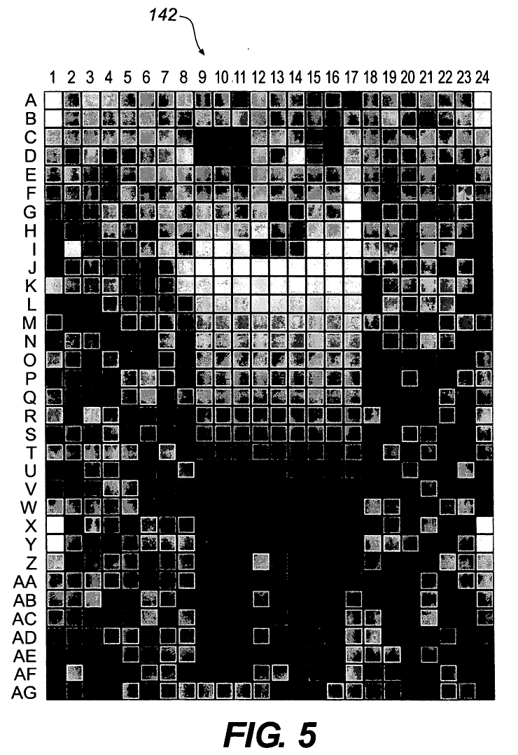

FIG. 4 depicts a preferred dynamic characterization target 142 produced using the method of the present invention and designed for easy visual verification and error reduction. This target 142 is a mix of fixed and dynamic patches. The fixed patches are:
Patches located in J12-Y14 and that correspond to equal RGB values.
Patches located in J9-Y11 and J15-Y17 and that correspond to near neutral control values.
Patches located in C9-I11, C15-I17, Z9-AF11, and Z15-AF17 and that correspond to color ramps.
Patches in scattered locations such as in B8, B11, etc. and that represent an 8×8×8 grid of control values.

The dynamic patches are:
Patches located in A1-J1, A24-J24, X1-AG1, and X24-AG24 and that correspond to visual neutrals.
Patches in scattered locations such as in B22, B23, etc. and that correspond to skin colors.
Patches in scattered locations such as in AD5, AE5, etc. and that correspond to the color of the sky.
Patches in scattered locations such as in E5, E6, etc. and that correspond to foliage.

FIG. 4 also depicts a preferred topology of the characterization target 142 when the target is designed to reduce measurement errors and enhance visual feedback. The balanced neutral patches are placed in the center of the characterization target. The code values for these patches decrease from a maximum of 255 to a minimum of 0 following a snake pattern in the region J12-Y14 to give a smooth neutral curve. The near neutral patches are placed alongside the balanced neutral patches with red, green, and blue to the left (J9-Y11) and cyan, magenta, and yellow to the right (JI5-Y17). This allows a user to visually examine if there are any abrupt changes in density in the near neutral patches as compared to the balanced neutral patches. Twelve (12) color patch ramps with code values at equal code values increments allow a user to visually examine any abrupt color or density changes. These 12 color ramps are placed in four regions on the characterization target. The red, green, and blue to near white patch ramps are placed in C9-J11; the red, green, and blue to near black ramps are in Y9-AF11; the cyan, magenta, and yellow to near white ramps are in C15-J17; and the cyan, magenta, and yellow to near black ramps are in Y15-AF17. Visual neutral patches are replicated at the four corners of the target in regions A1-J1, A24-J24, X1-AG1, and X24-AG24. The measurements of these four regions are averaged to handle potential left-right and top-bottom non-uniformity of the output device. The remaining color patches are arranged according to hue with reddish colors in the right, yellowish colors in the top, greenish colors in the left and bluish colors in the bottom. This arrangement also allows users to spot any big errors in hue reproduction in the target. User selected input colors 112 are not shown in this example as they are individual to the user and would typically be located in the patch regions arranged according to hue. As discussed above, this topology has verification and device behavior characteristics.

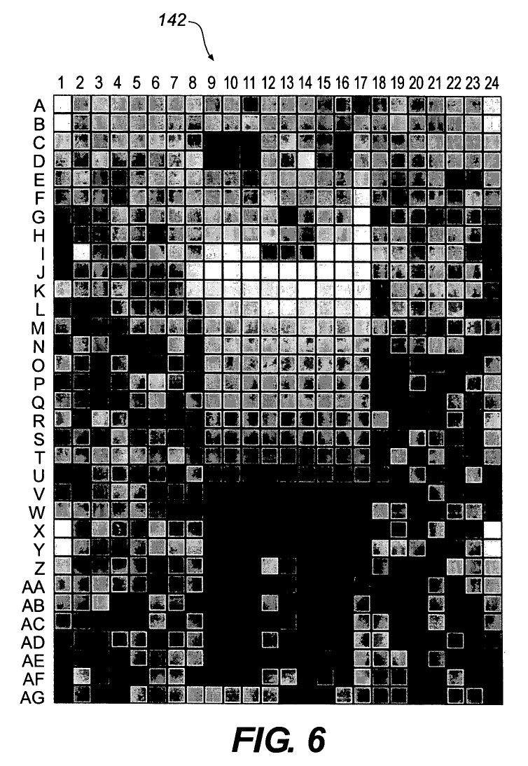

FIG. 5 illustrates a target 142 with one of the visual feedbacks that may alert users. In this case, it is the red to near white ramp that contains an abrupt change. More specifically, the transition between path F9 and path G9 is greater than what most user experienced in the field will expect. FIG. 6 illustrates a target 142 with another one of these visual feedbacks. In this case, there is a green patch amidst the reddish patches appearing in patch J22. This again will alert most users experienced in the field.

It should be noted that there can be many variations of the above patch arrangement that can be used for other purposes. For example, the ten visual neutral patches at the four corners of the characterization target can be formatted as 5 rows by 2 columns rather than 10 rows by 1 column as in FIG. 4. As a second example, the remaining color patches can be arranged with reddish colors on the top, yellowish colors on the right, greenish colors on the bottom, and bluish colors on the left. As a third example, there can be a relatively higher number of green patches in the target to give finer distinctions among green colors. As a fourth example, there can be more patches in the target to provide finer distinctions among all color regions. The patches can be randomly arranged when non-uniformities exist in the input/output device.

Each of the patches or color regions has a minimum size typically governed by the resolution of the calorimetric or other device used to measure the color. The typical minimum patch size is 5 mm±2 mm on a side. The number of patches that will fit on a particular target corresponds to the typical media for the device. For example, more patches will fit on an 8 by 10 print than on a 4 by 6 print.

The present invention has been described using a target that includes rectangular patches. Depending on the printer, the patches may have different shapes, such as strips for a strip printer.

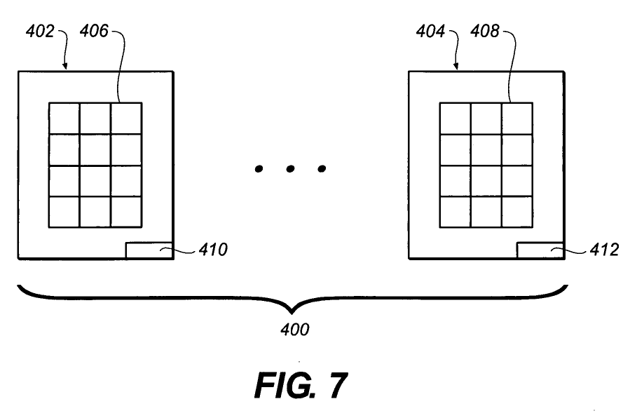

The present invention has been described above as including the characterization target on a single sheet of target media, such as a photographic print. However, the present invention can produce a characterization target 400, as depicted in FIG. 7, divided into a number of separate sub-targets 402, 404 provided via separate outputs, in this case output prints. Each of the sub-targets includes a subset 406, 408 of the patches of the target 400. The order of the subsets can be chosen to help accomplish different objectives, such as measuring only the first few subsets to characterize the device if the measurement resource is expensive or limited. The subsets can be arranged in a favorable topology within each sub-target as previously discussed. It is important that the order of the subsets be maintained to create the characterization. This is because each one of the patches corresponds to a particular code value provided to the output device and the correlation between code values and patches must be strictly maintained to produce an accurate characterization. This ordering can be maintained by providing each sub-target 402, 404 with a corresponding identifier 410, 412 that can be detected and input at the time the target is measured. The identifiers can be optically readable characters, a bar code, magnetic patterns that can be scanned, punched holes, etc. or even special color patches. The identifier is shown on the front of the sub-target but could also be on the rear or some other location that allows the correlation to be maintained, such as a separate pre-scan identifier sheet.

The system can also include a user interface that will allow the user to not only select the colors for the dynamic values, but also to select the size media (4×6 vs. 8×10), the total number of patches, etc., the system would then create the number of sub-targets necessary to accommodate the user's needs.

Typically, the more color patches in the target, that sample all regions of the device gamut, the more accurate the final device characterization. A target or set of sub-targets with a total of 1000 to 2000 patches is common for most devices.

In the above description, a preferred embodiment of the present invention has been described in terms of a system that would ordinarily be implemented as a software program. Those skilled in the art will readily recognize that the equivalent of such software may also be constructed in hardware. Because image manipulation algorithms and systems are well known, the present description has been in particular to algorithms and systems forming part of, or cooperating more directly with, the system and method in accordance with the present invention. Other aspect of such algorithms and systems, and hardware and/or software for producing and otherwise processing the image signals involved therewith, not specifically shown or described herein, may be selected from such systems, algorithms, components and elements known in the art. Given the system as described according to the invention in the above materials, software not specifically shown, suggested or described herein that is useful for implementation of the invention is conventional and within the ordinary skill in such arts.

Still further, as used herein, the computer program may be stored in a computer readable storage medium, which may comprise, for example; magnetic storage media such as magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program. The processes can also be distributed via, for example, downloading over a network such as the Internet.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### Appendix

Three Color Photographs as pages A1-A3 showing color versions of the targets of FIGS. 4, 5 and 6 for illustration purposes.

### Parts List

100 choice operation
102 fixed control values
112 user input colors
114 color databases
116 colorimetric measurement
118 visual neutrals
120 important color choice operation
122 important colorimetric values
124 existing characterization
130 compute dynamic control values operation
132 dynamic control values
140 generate target operation
142 dynamically created characterization target
200 compute calorimetric values operation
202 white point
204 relative colorimetric values
210 compute dynamic control values operation
212 transform
300 output device
310 computer
312 new characterization
400 characterization target
402, 404 sub-target
406,408 patch subset
410, 412 identifier

1. A method, comprising;
generating dynamic control values from dynamically selected colors using an existing characterization for a device; and
producing a characterization target for the device having color regions corresponding to the dynamic control values.

2. A method as recited in claim 1, further comprising:
combining predetermined fixed control values for the device with the dynamic control values and producing the characterization target from the dynamic control values and the predetermined fixed control values.

3. A method as recited in claim 1, wherein said generating comprises:
providing dynamic colorimetric values for the dynamically selected colors; and
determining the dynamic control values for the colorimetric colors using the existing characterization.

4. A method as recited in claim 3, wherein said determining comprises;
determining relative calorimetric values from the dynamic colorimetric values using a white point of the existing characterization; and
determining the dynamic control values for the relative calorimetric values using a profile transform of the existing characterization.

5. A method as recited in claim 1, wherein the producing comprises providing the color regions in a topology having one of verification and device behavior characteristics.

6. A method as recited in claim 1, wherein the existing output device characterization is an ICC profile.

7. A method as recited in claim 1, wherein the existing output device characterization is a characterization for a similar device.

8. A method as recited in claim 1, wherein the existing output device characterization is a characterization for a group of similar devices to which the device belongs.

9. A method for creating a dynamic output device characterization target using an existing characterization for the device, comprising;
choosing a set of important colors;
obtaining a set of calorimetric values corresponding to the important colors;
generating a set of dynamic control values by converting the colorimetric values to device control values using the existing characterization; and
producing the characterization target having patches corresponding to the device control values.

10. A method as recited in claim 9, wherein the existing output device characterization is an ICC profile.

11. A method as recited in claim 9, wherein the characterization target contains patches corresponding to a set of fixed control values.

12. A method, comprising:
producing predetermined sample control values for the device that uniformly sample a device color space;
generating dynamic control values from dynamically selected colors using an existing characterization for a device;
combining the predetermined control values for the device with the dynamic control values; and
producing a characterization target for the device having color regions corresponding to the dynamic control values and the predetermined control values.

13. A method, comprising:
producing predetermined sample control values for a device that uniformly sample a device color space of the device;
dynamically choosing important colors;
obtaining dynamic colorimetric values corresponding to the important colors;
generating dynamic control values by converting the calorimetric values to device control values using an existing ICC characterization for the device, comprising:
determining relative colorimetric values for the dynamic calorimetric values using a white point of the existing characterization; and
determining the dynamic control values from the relative calorimetric values using a profile transform of the existing characterization;
combining the predetermined control values for the device with the dynamic control values; and
producing a characterization target for the device having color regions corresponding to the dynamic control values and the predetermined control values comprising the color regions in a topology having verification and device behavior characteristics.

14. An apparatus, comprising:
a source for a characterization for a device; and
a computer obtaining predetermined fixed uniform sample control values for the device, producing dynamic control values from dynamically selected colors using the characterization, and producing a characterization target for the device having color regions corresponding to the dynamic control values and the predetermined fixed uniform sample control values.

15. A computer readable storage controlling a computer by obtaining predetermined fixed uniform sample control values for the device, producing dynamic control values from dynamically selected colors using an existing device characterization, and producing a characterization target for the device having color regions corresponding to the dynamic control values and the predetermined fixed uniform sample control values.

16. A characterization target, comprising:
first color regions having colors for predetermined fixed uniform sample control values for a device; and
second color regions having dynamic control values from dynamically selected colors produced using an existing characterization for the device.

17. A target as recited in claim 16, wherein the colors are color patches arranged in one of balanced neutral colors patches placed in the center of the characterization target and colors decrease in code value in a snake pattern, near neutral color patches placed alongside of the center, twelve color ramps of color patches with code values at equal code value increments placed around the center, near white ramps color patches placed around the center, visual neutral color patches replicated in four corners, same hues in a same region, color patches arranged in a color wheel and randomly.

18. A target as recited in claim 16, wherein the first and second color regions are subdivided into distinct sub-targets.

19. A target as recited in claim 18, wherein the colors on the sub-target have one of similar density levels and similar hue.

20. A target as recited in claim 18, further comprising a sub-target identifier.
